(19) United States
(12) Patent Application Publication
(10) Pub. No.: US 2022/0001263 A1
(43) Pub. Date: Jan. 6, 2022

(54) Smart Wearable Device, a Motion Detector, and a Feedback Mechanism Thereof

(71) Applicant: Xiamen HengTuo Electronic & Information Co., Ltd., Xiamen City (CN)

(72) Inventors: Cheng Zhang, Xiamen City (TW); Qi-Jing You, Xiamen City (CN); Shao-Xiong Xu, Xiamen City (CN); Fei Cai, Xiamen City (CN); Zheng-Jie Jiang, Xiamen City (CN)

(21) Appl. No.: 17/178,514

(22) Filed: Feb. 18, 2021

(30) Foreign Application Priority Data
Jul. 1, 2020 (CN) 202010620556.6
Jul. 1, 2020 (CN) 202021253697.0
Nov. 24, 2020 (CN) 202022753064.2

(51) Int. Cl. A63B 71/14; G06F 1/16; A63B 24/00

(52) U.S. Cl. CPC A63B 71/145; G06F 1/163; A63B 24/0021; G06F 1/1694; A63B 24/0006

(57) ABSTRACT

A disclosed feedback method for a smart wearable device includes the following steps: acquiring characterized information of a current motion; searching the database to determine whether corresponding characterized information of motion is found in a database based on the acquired characterized information; prompting to notify that the user's motion is correct, recording the acquired characterized information to have a segmented data, and inserting the segmented data into to the database if the corresponding characterized information is found; and prompting to notify that the user's motion is incorrect if the corresponding characterized information is not found. A motion detector implementing the method and a smart wearable device are also provided.

### BACKGROUND

### 1. Technical Field

The present application is related to the network field, and more particular to a smart wearable device and the feedback mechanism thereof.

### 2. Description of Related Art

A smart wearable device is capable of recording the real-time data of a user when the user is working out and is capable of synchronizing the data onto a mobile system such as an iOS (iPhone Operation System) device or an Android device. Therefore, the user can work out based on the instruction of said mobile system.

However, there is few the conventional wearable device capable of providing feedback regarding how precise the motion of the user is. Hence, the users could hardly adjust their movement more precisely according to the feedback, not to mention to reduce the risk of sports injury or to improve the quality of exercise.

### SUMMARY

In one embodiment of this disclosure, a feedback method for a smart wearable device includes the following steps: acquiring characterized information of a current motion; searching the database to determine whether corresponding characterized information of motion is found in a database based on the acquired characterized information; prompting to notify that the user's motion is correct, recording the acquired characterized information to have a segmented data, and inserting the segmented data into to the database if the corresponding characterized information is found; and prompting to notify that the user's motion is incorrect if the corresponding characterized information is not found.

In one embodiment of this disclosure, a motion detector for implementing the aforementioned method has a signal transceiver, a power cell, an indicator, a 3-dimensional (3D) motion sensor, a Bluetooth, and a wired connection port.

In one embodiment of this disclosure, a smart wearable device has a wearable component and an aforementioned motion detector, wherein the motion detector is connected to the wearable component.

### BRIEF DESCRIPTION OF THE DRAWINGS

FIG. 1 is a boxing glove according to one embodiment of this disclosure;

FIG. 2 illustrates a motion detector in one embodiment of this disclosure;

FIG. 3 illustrates another embodiment of the boxing glove;

FIG. 4 illustrates another embodiment of the boxing glove;

FIG. 5 illustrates a portion of the smart wearable device in another embodiment;

FIG. 6 illustrates a portion of the smart wearable device in another embodiment; and

FIG. 7 illustrates the boxing glove in an alternative embodiment.

### DETAILED DESCRIPTION

The disclosure will be best understood by reference to the following detailed description of illustrative embodiments when read in conjunction with the accompanying drawings.

Unless otherwise noted, similar elements will be identified by identical numbers throughout all figures.

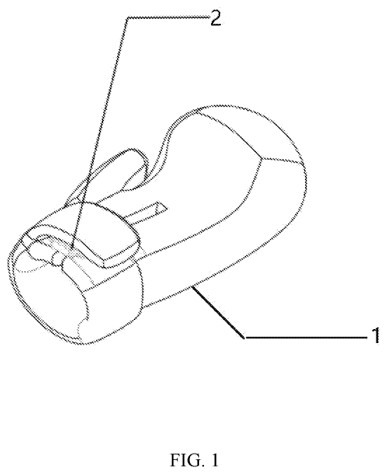

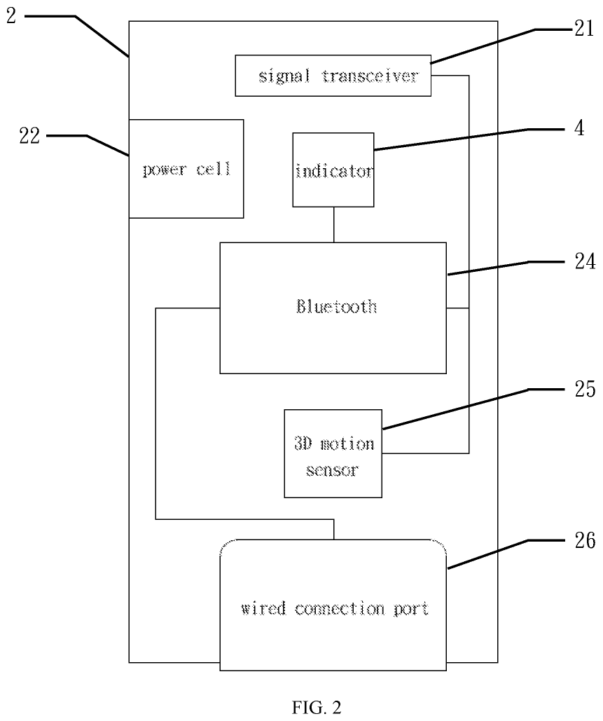

Please refer to FIG. 1 and FIG. 2, wherein FIG. 1 is a boxing glove and FIG. 2 illustrates a motion detector. The boxing glove 1 which is a smart wearable device has the motion detector 2 therein, and the motion detector 2 integrates a signal transceiver 21, a power cell 22, an indicator 4, a 3-dimensional (3D) motion sensor 24, a Bluetooth 25, and a wired connection port 26. The 3D motion sensor 24 is configured to record the data of position, velocity, and time. The signal transceiver 21, the Bluetooth 25, and the wired connection port 26 provide the capability of connecting to a smart terminal so as to perform the data synchronization. The indicator 4 is to indicate whether the motion or movement is correct or not, and the power cell 22 is, e.g. a battery, for providing electricity power to the motion detector 22.

In one embodiment of this disclosure, the smart wearable device is capable of realizing the feedback functionality corresponding to the motion according to the following steps, providing that the database, on the cloud or built in, has characterized information of standard motions including the data of position, velocity, and time:

Step 301, acquiring the characterized information of the current motion with the 3D motion sensor;

Step 302, sending the acquired characterized information to the smart terminal and searching the database to determine whether a corresponding characterized information of motion is found, then going to step s303 if affirmative while going to step s304 otherwise;

Step 303, prompting to notify that the user's motion is correct, recording the acquired characterized information to have a segmented data, and inserting the segmented data into to database; and

Step 304, prompting to notify that the user's motion is incorrect.

As to the step 302, the determination is, in one embodiment, made according to the following steps:

Step 401, determining whether there is a piece of characterized information in the database identical to the acquired characterized information, and proceeding to step 403 if affirmative or to step 402 otherwise;

Step 402, proceeding to step 403 if the difference between the characterized information in the database and the acquired characterized information is less than 5%, or to step 404 otherwise;

Step 403, determining that the corresponding characterized information is found;

Step 404, determining that the corresponding characterized information is not found.

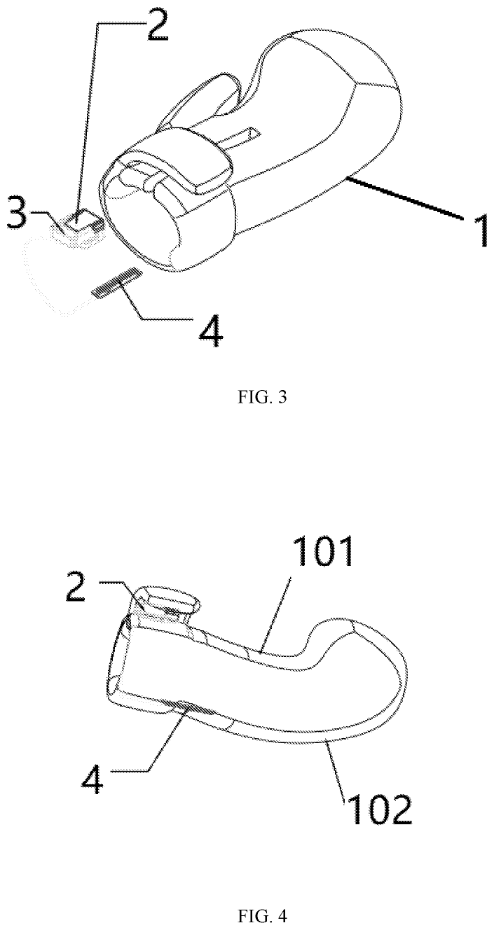

In one embodiment, please refer to FIG. 3 and FIG. 4, which illustrate another embodiment of the boxing glove. In this embodiment, the boxing glove 1 further has the detector socket 3 and the indicator 4 is now the light-emitting diode (LED) pad 4. The detector socket 3 is fixed on the inner surface 101 at the wrist portion of the boxing glove 1 and the LED pad 4 is embedded on the backside 102 of the boxing glove 1 and is connected to the motion detector 2. The motion detector 2 is buckled-connected to the detector socket 3.

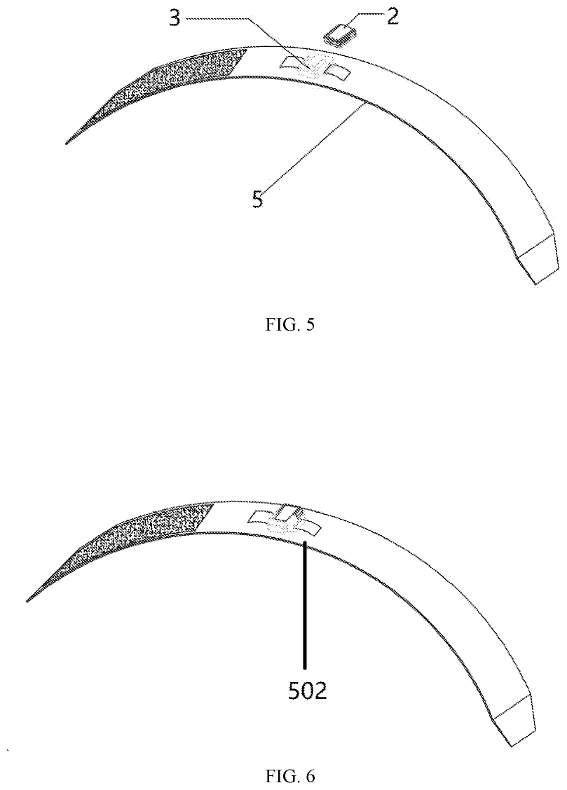

In another embodiment, please refer to FIG. 5 and FIG. 6, which illustrate a portion of the smart wearable device in another embodiment. The boxing glove 1 (smart wearable device) in this embodiment, compared with that in the embodiment of FIG. 1, further has a detector socket 3 and a wristband 5. In this embodiment, the motion detector 2 is inserted in the detector socket 3 and the detector socket 3 is fixed on the outside surface 502 of the wristband 5.

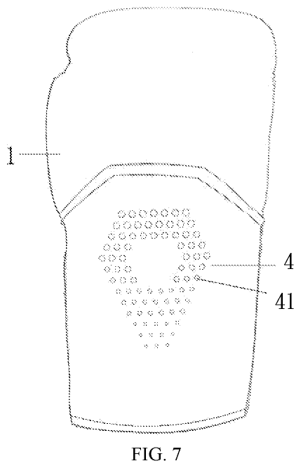

In an alternative embodiment, please refer to FIG. 7, which illustrates the boxing glove in an alternative embodiment. In this embodiment, the light source array 4 which is an alternative of the indicator 4 in FIG. 1 is disposed on the backside of the boxing glove 1. The light source array 4 has a plurality of light unit 41 so that the displayed pattern may vary, in color or in shape, according to the motions to provide the feedback of the motion of the user wearing the boxing glove.

The present disclosure has been described with reference to the abovementioned embodiments and it is understood that the embodiments are not intended to limit the scope of the present disclosure. Moreover, as the contents disclosed herein should be readily understood and can be implemented by a person skilled in the art, all equivalent changes or modifications which do not depart from the concept of the present disclosure should be encompassed by the appended claims.

What is claimed is:

1. A feedback method for a smart wearable device, comprising:
acquiring characterized information of a current motion;
searching the database to determine whether corresponding characterized information of motion is found in a database based on the acquired characterized information;
prompting to notify that the user's motion is correct, recording the acquired characterized information to have a segmented data, and inserting the segmented data into to the database if the corresponding characterized information is found; and
prompting to notify that the user's motion is incorrect if the corresponding characterized information is not found.

2. The method according to claim 1, wherein the database initially has the standard characterized information of motions.

3. The method according to claim 3, wherein the corresponding characterized information of motion is determined to be found in the database if there is a piece of characterized information in the database identical to the acquired characterized information or a difference between the piece of characterized information in the database and the acquired characterized information is less than 5%.

4. The method according to claim 1, wherein the acquired characterized information comprises data of position, data of velocity, and data of time of the smart wearable device.

5. The method according to claim 1, wherein the motion is a motion of boxing.

6. A motion detector for implementing the method in claim 1, comprising a signal transceiver, a power cell, an indicator, a 3-dimensional (3D) motion sensor, a Bluetooth, and a wired connection port.

7. The motion detector according to claim 6, wherein the motion detector is controlled by a remote terminal which is a mobile phone, a tablet, or an application program.

8. The motion detector according to claim 6, wherein the 3D motion sensor is a 9-axis accelerometer or a 6-axis accelerometer.

9. A smart wearable device, comprising a wearable component and a motion detector in claim 6, wherein the motion detector is connected to the wearable component.

10. The smart wearable device according to claim 9, wherein the wearable component is a wristband or a boxing glove.

11. The smart wearable device according to claim 10, wherein the wearable component is the boxing glove and the motion detector is fixed in an inner surface of a wrist portion of the boxing glove.

12. The smart wearable device according to claim 11, wherein the indicator is a light-emitting-diode (LED) pad, and the LED pad is embedded in a backside of the boxing glove.

13. The smart wearable device according to claim 10, wherein the wearable component is the wristband, and the motion detector is fixed on an outside surface of the wristband.
